(19) United States
(12) Patent Application Publication
(10) Pub. No.: US 2026/0128377 A1
(43) Pub. Date: May 7, 2026

(54) ELECTROLYTE WITH HIGH LIFSI CONCENTRATION

(71) Applicant: ARKEMA FRANCE, Puteaux (FR)

(72) Inventors: Julien JOUANNEAU, Puteaux (FR); Jean-Luc COUTURIER, Puteaux (FR); Marie BICHON, Puteaux (FR)

(73) Assignee: ARKEMA FRANCE, Puteaux (FR)

(21) Appl. No.: 19/486,731

(22) PCT Filed: May 13, 2024
(86) PCT No.: PCT/FR2024/050611

§ 371 Date: Nov. 21, 2025

(30) Foreign Application Priority Data
May 25, 2023 (FR) FR2305188

(51) Int. Cl. H01M 10/0568; H01M 4/505; H01M 4/587; H01M 4/66; H01M 10/0525; H01M 10/0569

(52) U.S. Cl. CPC H01M 10/0568; H01M 4/505; H01M 4/587; H01M 4/661; H01M 10/0525; H01M 10/0569; H01M 2300/0028

(57) ABSTRACT

The invention relates to an electrolyte composition comprising:
5% to 70% by weight of lithium bis(fluorosulfonyl)imide salt;
20% to 85% by weight of at least one organic solvent.

The present invention also relates to electrochemical cells and batteries using such an electrolyte composition.

### FIELD OF THE INVENTION

The present invention relates to an electrolyte composition comprising a lithium bis(fluorosulfonyl)imide salt. The present invention also relates to an electrochemical cell comprising said composition and to a battery comprising said electrochemical cell.

### TECHNICAL BACKGROUND

Lithium (Li) batteries, such as lithium-ion (Li-ion) batteries, are commonly used in electric vehicles and in mobile and portable devices.

An Li-ion battery comprises at least a negative electrode (anode), a positive electrode (cathode), an electrolyte and preferably a separator. The electrolyte generally consists of a lithium salt dissolved in a solvent which is generally a mixture of organic solvents, in order to have a good tradeoff between the viscosity and the dielectric constant of the electrolyte. The development of higher-power batteries is required for the Li-ion battery market. This is done by increasing the nominal voltage of Li-ion batteries. Li-ion batteries using high-voltage cathodes (typically >4.5 V) such as LMNO represent a considerable challenge for increasing the energy density of the battery. The key is then to find electrolytes which are stable at high voltages and compatible with the aluminum current collector, which guarantee the lifespan of the battery. Moreover, to achieve the targeted voltages, high-purity electrolytes are required.

In the field of Li-ion batteries, the salt that is currently most widely used is LiPF₆. This salt presents many drawbacks, such as limited thermal stability, sensitivity to hydrolysis and thus poorer safety of the battery.

New sulfonylimide lithium salts have been developed to try to improve battery performance, particularly LiTFSI (lithium bis(trifluoromethanesulfonyl)imide) and LiFSI (lithium bis(fluorosulfonyl)imide). These salts show little or no spontaneous decomposition, and are more stable to hydrolysis than LiPF₆. However, LiTFSI has the drawback of being corrosive toward aluminum current collectors.

The passivation layers formed during the first charge/discharge cycles of a battery are essential for its lifespan. Passivation layers include in particular the passivation of aluminum, which is generally the current collector used at the cathode, and the solid-electrolyte interface (SEI), which is the inorganic and polymeric layer that is formed at the anode/electrolyte and cathode/electrolyte interfaces. The stability of these interfaces is a substantial challenge for improving battery lifespan.

Document WO2018/150131 relates to a lithium bis(fluorosulfonyl)imide salt, characterized in that, after dissolution in water to form an aqueous solution, said aqueous solution has a pH of between 4 and 8, in particular at a temperature of 25° C., and to the uses thereof in Li-ion batteries.

The article by C. Luo et al., Electrochimica Acta 419 of 2022(p.140353 ), studies the corrosion of LiFSI on aluminum and on stainless steel. The proposed solution is to use a concentrated electrolyte solution in the presence of a fluorinated diluent (LHCE).

The article by B. Aktekin et al., Applied Energy Material 2022, 5, 1 (pp. 585-595), describes an electrolyte with a high concentration of LiFSI (2-6 M) in ethylene carbonate.

Document JP2019220450 claims an electrolyte that suppresses aluminum corrosion in an Li-ion battery. The solution is a concentration greater than 2 mol/kg of lithium salt including LiFSI in an oxygen-containing solvent (typically methyl 3-methoxypropionate and triethylene glycol dimethyl ether).

Document CN104300176 claims an electrolyte containing LiPF6 and LiFSI in the presence of corrosion inhibitors such as LiBOB.

There is a real need to provide electrolytes that can be used at high cut-off voltages, in particular of greater than 4.5 V, without adversely affecting the lifespan and the electronic performance of Li-ion batteries. There is also a real need to provide more highly performing electrolytes, which are free of aluminum corrosion over a long period of time and at temperatures that may exceed 40° C.

### SUMMARY OF THE INVENTION

The invention relates firstly to an electrolyte composition comprising:
5% to 70% by weight of lithium bis(fluorosulfonyl)imide salt;
20% to 85% by weight of at least one organic solvent.

According to a preferred embodiment, the organic solvent is chosen from ethers; carbonic acid esters or organic carbonates; cyclic carbonates; carboxylic acid esters; lactones; phosphoric acid esters; nitriles; amides; lactams; nitro compounds; sulfones; sulfoxides; ionic liquids with an FSI (bis(fluorosulfonyl)imide) anion with a cation of ammonium, imidazolium, pyrrolidinium, piperidinium, phosphonium, sulfonium or oxonium type; fluorinated solvents, and mixtures thereof, and is preferably chosen from sulfones, sulfoxides, nitriles, ionic liquids, fluorinated ethers and fluorinated carbonates, and mixtures thereof.

The solvent is preferably sulfolane.

According to another preferred embodiment, the electrolyte composition comprises from 10% to 60% by weight, preferably from 15% to 50% by weight, more preferentially from 20% to 40% by weight of LiFSI relative to the total weight of the electrolyte composition.

In a preferred embodiment, the electrolyte composition comprises from 30% to 85% by weight, preferably from 40% to 85% by weight, more preferentially from 50% to 80% by weight, more preferentially still from 60% to 75% by weight of solvent relative to the total weight of the electrolyte composition.

In a preferred embodiment, the electrolyte composition further comprises aluminum salts dissolved so as to have a weight concentration of aluminum relative to the weight of the electrolyte composition of between 0.5 and 10 000 ppm by weight, preferably between 0.5 and 9000 ppm, preferably between 0.5 and 8000 ppm, preferably between 0.5 and 7000 ppm, preferably between 0.5 and 6000 ppm, preferably between 0.5 and 5000 ppm, preferably between 0.5 and 4000 ppm, preferably between 0.5 and 3000 ppm, preferably between 0.5 and 2000 ppm, preferably between 0.5 and 1000 ppm, preferably between 0.5 and 900 ppm, preferably between 0.5 and 800 ppm, preferably between 0.5 and 700 ppm, preferably between 0.5 and 600 ppm, preferably between 0.5 and 500 ppm, preferably between 0.5 and 400 ppm, preferably between 0.5 and 300 ppm, preferably between 0.5 and 200 ppm, preferably between 0.5 and 100 ppm, preferably between 0.5 and 90 ppm, preferably between 0.5 and 80 ppm, preferably between 0.5 and 70 ppm, preferably between 0.5 and 60 ppm, preferably between 0.5 and 50 ppm, preferably between 0.5 and 40 ppm, preferably between 0.5 and 30 ppm, preferably between 0.5 and 20 ppm, preferably between 0.5 and 10 ppm.

According to a preferred embodiment, the electrolyte composition exhibits in cyclic voltammetry a positive current difference between the forward sweep and the return sweep over the range from 4.2 to 5 volts in the 1^{st} cycle.

According to a preferred embodiment, the electrolyte composition has a pH of greater than or equal to 3.5, measured at a temperature of 25° C. after dilution at a mass ratio of 1:1 in distilled water having a pH of 6.5.

According to another aspect, the invention relates to an electrochemical cell comprising a negative electrode, a positive electrode and the electrolyte composition defined above, wherein preferably the negative electrode is made of graphite and the positive electrode is an LNMO electrode.

According to a preferred embodiment, the electrochemical cell comprises an aluminum current collector electrode support, which is preferably combined with the positive electrode.

According to another aspect, the present invention relates to a battery comprising at least one electrochemical cell as defined above.

In a preferred embodiment, the battery has a cut-off voltage of greater than or equal to 4.5 V.

According to another aspect, the invention relates to the use of the electrolyte composition defined above in an Li-ion battery, preferably in an Li-ion battery of a portable electronic device, for example a mobile telephone or portable computer, an Li-ion battery of an electric vehicle, or an Li-ion battery for storing renewable energy, for example photovoltaic or wind energy.

In a preferred embodiment, the Li-ion battery has a cut-off voltage of greater than or equal to 4.5 V.

According to another aspect, the invention relates to the use of the electrolyte composition as defined above for increasing the lifespan of an Li-ion battery and/or for improving the electronic performance of an Li-ion battery, preferably having a cut-off voltage of greater than or equal to 4.5 V.

The present invention makes it possible to meet the need expressed above. More particularly, it provides new electrolytes for Li-ion batteries, which preferably offer improved performance, in particular in terms of SEI quality, coulombic efficiency and/or lifespan, and which can be used at high cut-off voltages, in particular of greater than 4.5 V, for example an LMNO cathode and in particular a graphite/LMNO cell, without adversely affecting the lifespan and the electronic performance of the Li-ion batteries. The electrolytes of the present invention advantageously prevent corrosion of aluminum up to voltages of 5 V and form an SEI on a graphite anode.

The high concentration of lithium salt in the electrolyte solvent is advantageous especially for high-voltage applications (typically above 4.5 V). This high concentration prevents the transition metals from dissolving in the electrolyte and thus prolongs the lifespan of the battery.

This is accomplished by virtue of the electrolyte composition according to the invention. More particularly, the fact that the electrolyte composition according to the invention has a lithium bis(fluorosulfonyl)imide salt content of greater than or equal to 5% by weight reduces oxidation of electrolyte solvents and thus increases the stability and lifespan of the battery, in particular at potentials of greater than 4.5 V.

### DESCRIPTION OF THE FIGURES

FIG. 1 shows the voltammetry curves obtained with electrolytes 1 and 2 according to the examples. The arrows indicate the direction of the sweep.

FIG. 2 shows the capacity retention and coulombic efficiency of 3 LNMO/graphite button cells with electrolytes 1 and 2 according to the examples.

FIG. 3 shows the surface of the aluminum after 200 cycles of voltammetry testing at 60° C. with electrolytes 1 (b) and 2 (a) according to the examples.

### DETAILED DESCRIPTION

The invention will now be described in greater detail and in a nonlimiting manner in the description that follows.

In the context of the invention, and unless otherwise mentioned, the term “cut-off voltage” means the upper voltage limit of a battery considered as being totally charged. The cut-off voltage is usually chosen so as to obtain the maximum capacity of the battery.

### Electrolyte Composition

The present invention relates to an electrolyte composition comprising a lithium bis(fluorosulfonyl)imide salt (LIFSI). In the context of the invention, the terms “lithium bis(fluorosulfonyl)imide salt”, “lithium bis(fluorosulfonyl)imide”, “LiFSI” and “LIN(FSO₂)₂” are used equivalently.

The electrolyte composition has a lithium bis(fluorosulfonyl)imide salt content of 5% to 70% by weight relative to the total weight of the electrolyte composition. The LiFSI content in the electrolyte can be determined by NMR. This content may be from 10% to 60% by weight, preferably from 15% to 50% by weight, more preferentially from 20% to 40% by weight, relative to the total weight of the electrolyte composition.

The electrolyte composition according to the invention is preferably non-aqueous or essentially non-aqueous. In the context of the present invention, the term “essentially non-aqueous” means a water content in the electrolyte composition of less than or equal to 50 ppm of water, preferably less than or equal to 20 ppm of water.

The electrolyte composition has an organic solvent content of 20% to 85% by weight relative to the total weight of the electrolyte composition.

The organic solvents may be chosen from ethers; carbonic acid esters or organic carbonates; cyclic carbonates; carboxylic acid esters; lactones; phosphoric acid esters; nitriles; amides; lactams; nitro compounds; sulfones; sulfoxides; ionic liquids with an FSI (bis(fluorosulfonyl)imide) anion with a cation of ammonium, imidazolium, pyrrolidinium, piperidinium, phosphonium, sulfonium or oxonium type; fluorinated solvents.

The ethers may in particular be chosen from ethylene glycol dimethyl ether (1,2-dimethoxyethane), ethylene glycol diethyl ether, triethylene glycol dimethyl ether, tetraethylene glycol dimethyl ether, tetrahydrofuran, 2-methyltetrahydrofuran, 2,6-dimethyltetrahydrofuran, tetrahydropyran, 1,4-dioxane and 1,3-dioxolane.

The carbonic acid esters or organic carbonates may be chosen from dimethyl carbonate (DMC), ethyl methyl carbonate (EMC), diethyl carbonate (DEC), diphenyl carbonate and methyl phenyl carbonate.

The cyclic carbonates may be chosen from ethylene carbonate (EC), propylene carbonate (PC), butylene carbonate, vinylene carbonate (VC) and vinyl-ethylene carbonate (VEC).

The carboxylic acid esters may be chosen from methyl formate, methyl acetate, methyl propionate, ethyl acetate, propyl acetate, butyl acetate, amyl acetate, vinyl acetate, divinyl adipate, methyl benzoate and ethyl benzoate.

The lactones may be chosen from γ-butyrolactone, γ-valerolactone and δ-valerolactone.

The phosphoric acid esters may be chosen from trimethyl phosphate, dimethyl ethyl phosphate, diethyl methyl phosphate and triethyl phosphate.

The nitriles may be chosen from acetonitrile, propionitrile, methoxypropionitrile, glutaronitrile, adiponitrile, sebaconitrile, 2-methylglutaronitrile, valeronitrile, butyronitrile, isobutyronitrile, benzonitrile and tolunitrile.

The amides may be chosen from N-methylformamide, N-ethylformamide, N, N-dimethylformamide and N, N-dimethylacetamide.

The lactams may be chosen from N-methylpyrrolidone, N-butylpyrrolidone and N-vinylpyrrolidone.

The nitro compound may, for example, be nitromethane.

The sulfones may be chosen from dimethyl sulfone, ethyl methyl sulfone, diethyl sulfone, sulfolane, 3-methylsulfolane, 2,4-dimethylsulfolane and sulfolene.

The sulfoxides may be chosen from dimethyl sulfoxide, methyl ethyl sulfoxide and diethyl sulfoxide. The ionic liquids may be chosen from EMIM-FSI (1-ethyl-3-methylimidazolium bis(fluorosulfonyl)imide), BMIM-FSI (1-butyl-3-methylimidazolium bis(trifluoromethylsulfonyl)imide), PYR14-FSI (1-butyl-1-methylpyrrolidinium bis(fluorosulfonyl)imide), PYR13-FSI (1-propyl-3-methylpyrrolidinium bis(fluorosulfonyl)imide), PIP14-FSI (1-butyl-1-methylpiperidinium bis(fluorosulfonyl)imide), PIP13-FSI (1-methyl-1-propylpiperidinium bis(fluorosulfonyl)imide), P1444-FSI (methyl(tri-n-butyl)phosphonium bis(fluorosulfonyl)imide) and P1222-FSI (methyl(tri-n-ethyl)phosphonium bis(fluorosulfonyl)imide).

The fluorinated solvents may be chosen from fluorinated ethers, fluorinated esters, fluorinated orthoformates, fluorinated carbonates, fluorinated phosphates, fluorinated phosphites or fluorinated sulfates. Non-exhaustive mention may be made of 1,1,2,2-tetrafluoroethyl methyl ether, 1,1,2,2-tetrafluoroethyl ethyl ether, 1,1,2,2-tetrafluoroethyl 2,2,2-trifluoroethyl ether, 1,1,2,2-tetrafluoroethyl 2,2,3,3-tetrafluoropropyl ether, hexafluoroisopropyl methyl ether, 1,1,3,3,3-pentafluoro-2-trifluoromethylpropyl methyl ether, 1,1,2,3,3,3-hexafluoropropyl methyl ether, 1,1,2,3,3,3-hexafluoropropyl ethyl ether, 1,1,1,3,3,3-hexafluoro-2-(2,2,2-trifluoroethoxy)propane, bis(2,2,2-trifluoroethyl) ether, 1,1,2,2-tetrafluoroethyl 2,2,2-trifluoroethyl ether, methoxynonafluorobutane, ethoxynonafluorobutane, 1,2-(1,1,2,2-tetrafluoroethoxy)ethane, 2,2,3,3-tetrafluoro-1,4-dimethoxybutane, 2-(2-ethoxyethyl)-1,1,1-trifluoroethane, 2-(2-(2,2-difluoroethoxy)ethoxy)-1,1-difluoroethane, 2-(2-(2,2-difluoroethoxy)ethoxy)-1,1,1-trifluoroethane, 1,1,1-trifluoro-2-(2-(2-trifluoroethoxy)ethoxy)ethane, 2,2-difluoroethyl acetate, 2,2,2-trifluoroethyl acetate, 2,2-difluoroethyl propionate, 3,3-difluoropropyl acetate, 3,3-difluoropropyl propionate, ethyl 4,4-difluorobutanoate, difluoroethyl formate, trifluoroethyl formate, 2,2,2-trifluoroethyl orthoformate, 4-fluoro-1,3-dioxolan-2-one (F1EC), 4,5-difluoro-1,3-dioxolan-2-one (F2EC), ethyl 1- fluoroethyl carbonate (F1DEC), 1-fluoroethyl 2,2,2-trifluoroethyl carbonate (F4DEC), bis(2,2,2-trifluoroethyl) carbonate (BFEC), 2,2,2-trifluoroethyl methyl carbonate (F3EMC), trifluoropropylene carbonate, monofluorodimethyl carbonate, methyl 2,2,2-trifluoroethyl carbonate, 2,2-difluoroethyl methyl carbonate, trifluoroethyl ethyl carbonate, methyl hexafluoroisopropyl carbonate, ethyl hexafluoroisopropyl carbonate, bis(trifluoroethyl) carbonate, propyl trifluoroethyl carbonate, fluorotoluene and 1,4-dimethoxytetrafluorotoluene.

The solvents may be used alone or in combination.

Sulfones, sulfoxides, nitriles, ionic liquids, fluorinated ethers and fluorinated carbonates are preferred. Among the ionic liquids, the classes of pyrrolidiniums, piperidiniums and phosphoniums are preferred.

Sulfones, and in particular sulfolane, are more preferred.

The content of organic solvent in the electrolyte composition according to the invention is preferably between 30% and 85% by weight relative to the total weight of the electrolyte composition, preferably between 40% and 85% by weight, more preferentially between 50% and 80% by weight, more preferentially still between 60% and 75% by weight, relative to the total weight of the electrolyte composition.

The electrolyte composition according to the invention may optionally comprise one or more additives. Said additives may in particular be chosen from lithium salts other than LIFSI, organic compounds comprising silicon, organic compounds comprising boron, anhydrides and compounds comprising aluminum.

The additional lithium salts other than LiFSI may be chosen from LiPF₆ (lithium hexafluorophosphate), LiTDI (lithium 2-trifluoromethyl-4,5-dicyanoimidazolate), lithium bis(trifluoromethanesulfonyl)imide (LiTFSI), lithium difluorophosphate (LiPO₂F₂), lithium bis(oxalato)borate (LiB(C₂O₄)₂), lithium difluoro(oxalato)borate (LIF₂B(C₂O₄)₂), lithium tetrafluorate (LiBF₄), lithium nitrate (LiNO₃), lithium perchlorate (LiClO₄), lithium fluoride (LiF) and lithium fluorosulfonate (FSO₃Li).

The organic compounds comprising silicon may in particular be chosen from diphenylsilanediol, dimethoxyphenylsilane, tetrakis(trimethylsilyl)silane, trimethylsilyl acetate, trimethylsilyl trifluoroacetate, trimethylsilyl trifluoromethanesulfonate, bistrimethylsilyl sulfate and tert-butyldimethylsilyl trifluoromethanesulfonate.

The organic compounds comprising phosphorus may in particular be chosen from tris(trimethylsilyl) phosphate, tris(hexafluoroisopropyl) phosphate, ethyl polyphosphate, bis(2,2,2-trifluoroethyl) phosphonate, trimethyl phosphite and tris(trimethylsilyl) phosphite (TMSPi).

The organic compounds comprising sulfur may in particular be chosen from propane sultone (PS), prop- 1-ene 1,3-sultone (PES), methylene methanedisulfonate (MMDS), ethylene sulfite, 1,4-butane sultone and methyl methanesulfonate.

The organic compounds comprising boron may in particular be chosen from trimethyl borate, triethyl borate, triisopropyl borate; tributyl borate, tris-2,2,2-trifluoroethyl borate, tris-trimethylsilyl borate, tris(pentafluorophenyl)borane, trimethoxyboroxine, triisopropylboroxine and triphenylboroxine.

The anhydrides may be chosen from maleic anhydride, succinic anhydride, glutaric anhydride, citraconic anhydride, glutaconic anhydride, itaconic anhydride, diglycolic anhydride, cyclohexanedicarboxylic anhydride, cyclopentanetetracarboxylic dianhydride and phenylsuccinic anhydride.

The compounds comprising aluminum, preferably in salt form, may be chosen from aluminum tris-bis(fluorosulfonyl)imide (Al(FSI)₃=Al[(N(SO₂F)₂]₃), aluminum tris-bis(trifluoromethanesulfonyl)imide (Al(TFSI)₃=Al[(N(SO₂CF₃)₂]₃), aluminum acetate, aluminum acetylacetonate, aluminum carbonate, aluminum nitrate, aluminum chlorate, alkylaluminums such as triethylaluminum and aluminum alkoxides such as aluminum triethylate, preferably Al(FSI)₃.

The content of additive in the electrolyte composition may be from 0% to 10% by weight, preferably from 0% to 5% by weight, relative to the total weight of the electrolyte composition.

Preferably, the electrolyte composition of the invention comprises aluminum salts dissolved so as to have a weight concentration of aluminum in the electrolyte composition of between 0.5 and 10 000 ppm, preferably between 0.5 and 9000 ppm, preferably between 0.5 and 8000 ppm, preferably between 0.5 and 7000 ppm, preferably between 0.5 and 6000 ppm, preferably between 0.5 and 5000 ppm, preferably between 0.5 and 4000 ppm, preferably between 0.5 and 3000 ppm, preferably between 0.5 and 2000 ppm, preferably between 0.5 and 1000 ppm, preferably between 0.5 and 900 ppm, preferably between 0.5 and 800 ppm, preferably between 0.5 and 700 ppm, preferably between 0.5 and 600 ppm, preferably between 0.5 and 500 ppm, preferably between 0.5 and 400 ppm, preferably between 0.5 and 300 ppm, preferably between 0.5 and 200 ppm, preferably between 0.5 and 100 ppm, preferably between 0.5 and 90 ppm, preferably between 0.5 and 80 ppm, preferably between 0.5 and 70 ppm, preferably between 0.5 and 60 ppm, preferably between 0.5 and 50 ppm, preferably between 0.5 and 40 ppm, preferably between 0.5 and 30 ppm, preferably between 0.5 and 20 ppm, preferably between 0.5 and 10 ppm.

The content of aluminum in the electrolyte composition may be determined by any method known to a person skilled in the art and in particular by ICP-MS (inductively coupled plasma mass spectrometry), ICP-AES (inductively coupled plasma optical emission spectrometry) or X-ray fluorescence spectrometry, preferably by ICP-MS.

In one particular embodiment, the electrolyte composition according to the invention exhibits in cyclic voltammetry a positive current difference between the forward sweep and the return sweep over the range from 4.2 to 5 V in the first cycle. Cyclic voltammetry is carried out in a cell of three polypropylene Swagelok electrodes comprising an aluminum working electrode, optionally a lithium metal reference electrode, a lithium metal counter-electrode and the electrolyte composition. Cyclic voltammetry is carried out under the following conditions:
sweep from 3 to 5 V vs Li⁺/Li;
sweep rate of 1 mV/s
temperature of 60° C.

A positive current difference between the forward sweep and the return sweep over the range from 4.2 to 5 V means that, for any potential value Ei chosen between 4.2 and 5 V, the forward sweep current I_{A}(Eᵢ) is greater than the return sweep current I_{R}(Eᵢ), i.e. I_{A}(Eᵢ)-I_{R}(E;)>0.

Advantageously, an electrolyte composition exhibiting such a characteristic of the voltammetry curve makes it possible to avoid corrosion of aluminum, in particular making it possible to improve the lifespan and coulombic efficiency of a high-voltage cell.

In one particular embodiment, which may be combined with the preferences and other embodiments of the invention, the electrolyte composition according to the invention has a pH of greater than or equal to 3.5, measured at a temperature of 25° C. after dilution to a mass ratio of 1:1 in distilled water having a pH of 6.5. The pH may be greater than or equal to 4, and preferably from 4 to 8. Said pH may be from 3.5 to 4; or from 4 to 4.5; or from 4.5 to 5; or from 5 to 5.5; or from 5.5 to 6; or from 6 to 6.5; or from 6.5 to 7; or from 7 to 7.5; or from 7.5 to 8; or from 8 to 8.5; or from 8.5 to 9; or from 9 to 9.5; or from 9.5 to 10; or from 10 to 10.5; or from 10.5 to 11; or from 11 to 11.5; or from 11.5 to 12; or from 12 to 12.5; or from 12.5 to 13; or from 13 to 13.5; or 13.5; or from 13.5 to 14.

The pH may be measured via any method known to those skilled in the art. The pH may be measured, for example, using a glass electrode whose potential can vary as a function of the concentration of hydrogen ions according to the Nernst equation. This potential may be measured relative to a reference electrode using a high-impedance potentiometer, commonly known as a pH-meter. An example of a pH-meter that may be used is the pHM210 model from Radiometer. The pH-meter can be pre-calibrated using three buffer solutions (for example, at pH=4.0, 7.0 and 10.0). The aqueous solution may be stirred during the pH measurement. The pH is preferably measured within one hour of dilution in distilled water.

The fact that the aqueous solution (prepared by dissolving the lithium bis(fluorosulfonyl)imide salt in distilled water) has a pH of greater than or equal to 3.5 advantageously makes it possible to maintain the stability of the electrolyte with a high salt concentration at high voltage (greater than 4.5 V).

The electrolyte composition can be prepared by mixing the LiFSI salt, the one or more organic solvents, and optionally one or more additives. Preferably, the desired amount of lithium salts is dissolved in the organic solvent or solvents, and then the optional additives are added.

### Preparation of the Lithium Bis(fluorosulfonyl)imide Salt

The LiFSI can be obtained by any method known to those skilled in the art and in particular by the process described in WO2018/104674.

The invention relates to either the electrolyte initially charged in the battery or the electrolyte formed in situ during battery operation.

### Electrochemical Cell and Battery

The present invention also relates to the use of the above electrolyte composition in Li-ion batteries especially with a cathode at high voltage (greater than or equal to 4.5 V), in particular in Li-ion batteries of portable electronic devices, for example mobile telephones or portable computers, or of electric vehicles, or for storing renewable energy, for example photovoltaic or wind energy.

The present invention relates to the use of the electrolyte composition according to the invention for increasing the lifespan of an Li-ion battery and/or for improving the electronic performance (coulombic efficiency) of an Li-ion battery. More particularly, the present invention relates to the use of the electrolyte composition according to the invention for forming a stable SEI on graphite to increase the coulombic efficiency and the lifespan of the Li-ion battery.

The term “increase in lifespan of the Li-ion battery” is understood to mean the increase in the number of cycles allowing at least 80% of the initial capacity of the battery to be retained.

The term “improvement of the electronic performance (coulombic efficiency) of an Li-ion battery” is understood to mean the improvement of the capacity at high charging or discharging current, in particular at low temperature and/or after storage at high temperature.

The term “stable SEI on graphite” is understood to mean the realization of a delithiation capacity which is stable over 5 cycles, that is to say not changing by plus or minus 5%, and equal to at least 90% of the theoretical capacity of the active material. The delithiation capacity is realized during discharge in an Li/graphite half-cell cycling at constant current at C/10 in charge and discharge between 0.01 and 1 V. This capacity may be realized by any method known to those skilled in the art and for example by means of a CR2016 button cell assembly, comprising a stainless steel spring, a stainless steel shim 1 mm in diameter, a lithium metal pellet 14 mm in diameter, a fiberglass separator 16 mm in diameter and impregnated with 100 μL of electrolyte, and a graphite pellet 12 mm in diameter.

The invention also relates to an electrochemical cell comprising an electrolyte composition as described above. The electrochemical cell also comprises a negative electrode (or anode) and a positive electrode (or cathode). Preferably, the positive electrode (or cathode) operates at a high voltage (greater than or equal to 4.5 V).

The electrochemical cell can also comprise a separator, in which the electrolyte is impregnated.

A “negative electrode” means the electrode which acts as anode when the cell delivers current (that is to say, when it is in the process of discharging) and which acts as cathode when the cell is in the process of charging.

The negative electrode typically comprises an electrochemically active material, optionally an electrically conductive material, and optionally a binder.

A “positive electrode” means the electrode which acts as cathode when the cell delivers current (that is to say, when it is in the process of discharging) and which acts as anode when the cell is in the process of charging.

The “positive electrode” typically comprises an electrochemically active material, optionally an electrically conductive material, and optionally a binder.

The term “electrochemically active material” is understood to mean a material capable of reversibly inserting ions.

The term “electronically conductive material” is understood to mean a material that is capable of conducting electrons.

The negative electrode of the electrochemical cell can in particular comprise, as electrochemically active material, graphite, lithium, a lithium alloy, a lithium titanate of Li₄Ti₅O₁₂ type or titanium oxide TiO₂, silicon or a lithium-silicon alloy, a tin oxide, a lithium intermetallic compound, or a mixture thereof.

When the negative electrode comprises lithium, the latter can be in the form of a film of metallic lithium or of an alloy comprising lithium. Among the lithium-based alloys that may be used, examples that may be mentioned include lithium-aluminum alloys, lithium-silica alloys, lithium-tin alloys, Li-Zn, Li₃Bi, Li₃Cd and Li₃SB. An example of a negative electrode may comprise a bright lithium film prepared by rolling a lithium strip between rollers.

Preferably, the negative electrode is made of graphite.

The positive electrode comprises an electrochemically active material of lithium oxide type having:
a lamellar structure of formula LiMO₂ where M is a metal which may in particular be nickel, cobalt, manganese, aluminum, magnesium, titanium, chromium or a combination;
a spinel structure of formula LiM₂O₄ where M is a metal such as manganese or a combination of manganese with nickel, cobalt, copper, iron, chromium, in particular of formula LiNi_{0.5-x}Mn_{1.5+x}O₄ with x between 0 and 0.5, for example LiNi_{1/2}Mn_{3/2}O₄ (LNMO);
a spinel structure of formula LiMO₄ where M is a combination of manganese with cobalt, iron, chromium, nickel;
an olivine structure of formula LIMPO₄ where M is a metal such as nickel, cobalt, manganese or a combination of iron, nickel, manganese, cobalt;
a formula of type Li₁₊ₓM₁₋ₓO₂ where M is a metal such as nickel, cobalt, manganese, aluminum, magnesium, titanium, chromium or a combination of these metals;
a structure of type LiMVO₄ where M is a metal such as nickel;
a formula of type Li₂MPO₄F where M is a metal such as cobalt; or
a formula of type Li₃M2(PO₄)₃ where M is a metal such as nickel, cobalt, manganese, iron, vanadium or a combination of these metals.

Positive electrodes of these kinds are described in particular in the document Li, Wangda, Song, Bohang, & Manthiram, Arumugam, High-voltage positive electrode materials for lithium-ion batteries, Chemical Society Reviews, 2017, 46(10).

Preferably, the positive electrode is LNMO.

Alternatively or additionally, the positive electrode may comprise sulfur, Li₂S, O₂, and/or LiO₂ as electrochemically active material.

The material of each electrode may also comprise, besides the electrochemically active material, an electrically conductive material, such as a carbon source, including, for example, carbon black, Ketjen® carbon, Shawinigan carbon, graphite, graphene, carbon nanotubes, carbon fibers (for example, vapor-grown carbon fibers or VGCF), non-powdery carbon obtained by carbonization of an organic precursor, or a combination of two or more thereof. Other additives may also be present in the material of the positive electrode, such as lithium salts or inorganic particles of ceramic or glass type, or also other compatible active materials (for example sulfur).

The material of each electrode may also comprise a binder. Nonlimiting examples of binders comprise linear, branched and/or crosslinked polyether polymer binders (for example polymers based on poly(ethylene oxide) (PEO), or poly(propylene oxide) (PPO) or on a mixture of the two (or an EO/PO copolymer), and optionally comprising crosslinkable units), water-soluble binders (such as SBR (styrene/butadiene rubber), NBR (acrylonitrile/butadiene rubber), HNBR (hydrogenated NBR), CHR (epichlorohydrin rubber), ACM (acrylate rubber)), or binders of fluoropolymer type (such as PVDF (polyvinylidene fluoride), PTFE (polytetrafluoroethylene)), and combinations thereof. Certain binders, such as those that are water-soluble, may also comprise an additive, such as CMC (carboxymethylcellulose).

The metal supports of the electrodes serving as current collectors are generally made of aluminum for the cathode and of copper for the anode. The metal supports can be surface treated and have a conductive primer. The conductive primer may contain carbonaceous materials, metallic materials and polymeric materials, as described in the review by H. Jeong et al., Chemical Engineering Journal 446, 2022, 136860. The supports can also be woven or non-woven fabrics made of carbon fiber.

The separator must at one and the same time exhibit low thickness, sufficient mechanical strength and temperature resistance, good electrochemical resistance to the voltages to which it is exposed, optimal affinity for the electrolyte, and must more generally allow excellent ion conductivity. The separator can consist of a porous film (substrate). Examples of porous substrates that are useful in the invention as a separator include, without being limited to, polyolefins, polyethylene terephthalate, polybutylene terephthalate, polyester, polyacetal, polyamide, polycarbonate, polyimide, polyether ether ketone, polyether sulfone, poly(phenylene oxide), poly(phenylene sulfide), polyethylene naphthalene or mixtures thereof. Non-limiting examples of polyolefin separators include ethylene homopolymers, propylene homopolymers, ethylene/butene copolymers, ethylene/hexene copolymers, ethylene/methacrylate copolymers or multilayer structures of the above polymers.

Alternatively, the separator may be made of glass fibers. Nonwoven materials made of natural or synthetic materials may also be used as substrate of the separator. The porous substrate generally has a thickness of 1 to 50 μm, and is typically membranes obtained by extrusion and drawing (wet or dry processes) or cast nonwovens. The porous substrate preferably has a porosity of between 5% and 95%. The average size of the pores (diameter) is preferably of between 0.001 and 50 um, more preferably between 0.01 and 10 um.

The separator may comprise a coating. This coating may optionally be located on one or both faces of a porous support. In this case, the coating is used to coat the support of a separator, on at least one face, in the form of a monolayer or of multilayers. Said coating may be a fluoropolymer alone or as a mixture with an acrylic polymer. The fluoropolymer preferably comprises monomer units derived from vinylidene fluoride. The separator coating may contain inorganic particles which serve to form micropores in the coating (the interstices between inorganic particles). The addition of inorganic particles can also contribute to the heat resistance or improve the wettability. According to one embodiment, said inorganic particles are selected from the group consisting of: BaTiO3, Pb(Zr, Ti)O3, Pb1-xLaxZryO3 (0<x<1, 0<y<1), PbMg3Nb 2/3)3, PbTiO3, hafnia (HfO (HfO2), SrTiO3, SnO2, CeO2, MgO, NiO, CaO, ZnO, Y2O3, boehmite (y-AlO(OH)), Al2O3, TiO2, SiC, Zr02, boron silicate, BaSO4, nanoclays, or mixtures thereof.

The invention also relates to a battery comprising at least one, and preferably two or more, electrochemical cells as described above. The electrochemical cells can be assembled in series and/or in parallel in the battery.

Preferably, the battery according to the invention has a cut-off voltage of greater than or equal to 4.3 V, more preferably greater than or equal to 4.5 V.

### EXAMPLES

The following examples illustrate the invention without limiting it.

### Example 1

Electrolyte 1 is prepared by dissolving 2.9 g of LiFSI in 7.8 g of sulfolane.

The voltammetry curve of this electrolyte is obtained by making a Swagelok type polypropylene cell filled with electrolyte 1, and comprising an aluminum working electrode and a lithium metal counter-electrode.

The cyclic voltammetry conditions are as follows:
sweep from 3 to 5 V vs Li+/Li
sweep rate of 1 mV/s
temperature of 60° C.

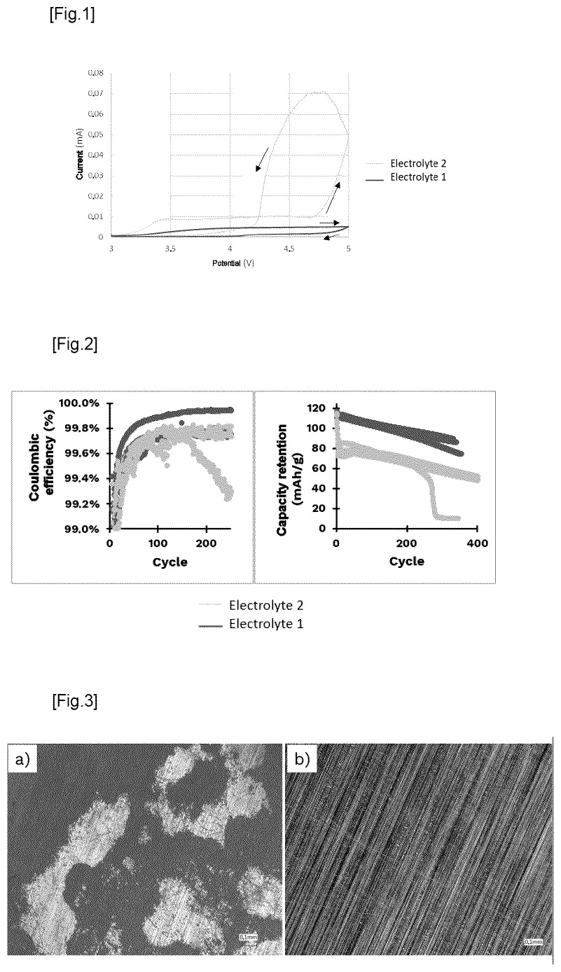

The voltammetry curve is shown in FIG. 1.

### Example 2 (comparative)

Electrolyte 2 is prepared by dissolving 0.76 g of LiPF 6, 0.1 g of LiFSI and 0.06 g of LiBOB in 1.98 g of ethyl carbonate (EC), 3.54 g of ethyl methyl carbonate (EMC) and 0.11 g of fluoroethylene carbonate (FEC).

The voltammetry curve of this electrolyte is obtained by making a Swagelok type polypropylene cell filled with electrolyte 2, and comprising an aluminum working electrode and a lithium metal counter-electrode.

The cyclic voltammetry conditions are as follows:
sweep from 3 to 5 V vs Li+/Li
sweep rate of 1 mV/s
temperature of 60° C.

The voltammetry curve is shown in FIG. 1.

FIG. 1 shows that electrolyte 1 according to the invention has, over the potential range from 4.2 to 5 V, a forward sweeping current greater than the return sweeping current, unlike electrolyte 2.

FIG. 3 shows that electrolyte 1 according to the invention does not corrode aluminum (b), unlike electrolyte 2, for which corrosion marks appear on aluminum (a).

### Example 3: Study of the Lifespan of a Battery With an Electrolyte 1 and an Electrolyte 2

Button cells are prepared for evaluating the impact of the electrolyte on the lifespan of a battery. The button cells are composed of a CR 2032 case made of 316L stainless steel. The inside of the button cell is composed of the lower case surrounded by a polypropylene seal, a 316L stainless steel spring, a 316L stainless steel shim 1 mm thick, a graphite anode cut into a disk with a diameter of 14 mm, a Whatman fiberglass separator impregnated with 100 μL of electrolyte 1 or 2, an LNMO cathode cut into a 12 mm disk, and an aluminum strip that completely covers the upper case.

The LNMO cathode is prepared by dispersing in a Thinky mixer 93% by weight of active material (LNMO TBM129, Haldor Topsoe), 4% by weight of carbon black (C65, Imerys) and 3% by weight of PVDF binder (Kynar® HSV 1810, Arkema) in the solvent NMP (N-methylpyrrolidone) to obtain 60% solids content. The ink thus obtained is coated onto an aluminum collector using the doctor blade of height 270 μm, at a speed of 0.2 m/min, then dried for 12 h at 90° C. in an oven.

The surface weight of active material on the cathode is 13.5mg/cm² . The electrode is calendered to obtain a porosity of 30%.

The graphite anode comes from the supplier NEI (reference BE-150E).

The surface weight of active material on the anode is 6.2mg/cm².

The electrodes and the separator are dried under vacuum for 12 h at 60° C. before the assembly of the cell, which is carried out under dry-room conditions at a dew point of −40° C.

The LNMO/graphite button cells are tested on a VMP3 potentiostat (Biologic). The test program consists of 2 formation cycles at C/10(10 -hour charge or discharge cycle) (charge in CCCV (constant current phase applied until potential reaches 4.85 V, followed by constant potential phase applied until the current drops below C/10), discharge in CC (constant current) between 3.5 V and 4.85 V, followed by 400 cycles with a charge at C/5(5 -hour charge or discharge cycle) in CCCV and a discharge in CC to 1 C, between 3.5 V and 4.85 V.

The change in the capacity and the coulombic efficiency of 3 cells containing electrolyte 1 and 3 cells containing electrolyte 2 is presented in FIG. 2.

The use of electrolyte 1 leads to an improvement in the lifespan of the battery and in the coulombic efficiency, in particular related to the absence of corrosion of the aluminum collector, relative to electrolyte 2.

1. An electrolyte composition comprising:
5% to 70% by weight of lithium bis(fluorosulfonyl)imide salt;
20% to 85% by weight of at least one organic solvent.

2. The electrolyte composition as claimed in claim 1, wherein the organic solvent is chosen from ethers; carbonic acid esters or organic carbonates; cyclic carbonates; carboxylic acid esters; lactones; phosphoric acid esters; nitriles; amides; lactams;
nitro compounds; sulfones; sulfoxides; ionic liquids with an FSI (bis(fluorosulfonyl)imide) anion with a cation of ammonium, imidazolium, pyrrolidinium, piperidinium, phosphonium, sulfonium or oxonium type; fluorinated solvents, and mixtures thereof.

3. The electrolyte composition as claimed in claim 1, wherein the solvent is sulfolane.

4. The electrolyte composition as claimed in claim 1, comprising from 10% to 60% by weight, of LiFSI relative to the total weight of the electrolyte composition.

5. The electrolyte composition as claimed in claim 1, comprising from 30% to 85% by weight, preferably from 40% to 85% by weight of solvent relative to the total weight of the electrolyte composition.

6. The electrolyte composition as claimed in claim 1, further comprising aluminum salts dissolved so as to have a weight concentration of aluminum relative to the weight of the electrolyte composition of between 0.5 and 10 000 ppm by weight.

7. The electrolyte composition as claimed in claim 1, exhibiting in cyclic voltammetry a positive current difference between the forward sweep and the return sweep over the range from 4.2 to 5 volts in the 1^{st} cycle.

8. The electrolyte composition as claimed in claim 1, wherein the composition has a pH of greater than or equal to 3.5, measured at a temperature of 25° C. after dilution at a mass ratio of 1:1 in distilled water having a pH of 6.5.

9. An electrochemical cell comprising a negative electrode, a positive electrode and the electrolyte composition as claimed in claim 1, wherein preferably the negative electrode is made of graphite and the positive electrode is an LNMO electrode.

10. The electrochemical cell as claimed in claim 9, comprising an aluminum current collector electrode support.

11. A battery comprising at least one electrochemical cell as claimed in claim 9.

12. The battery as claimed in claim 11, having a cut-off voltage of greater than or equal to 4.5 V.

13. A Li-ion battery comprising the electrolyte composition as claimed in claim 1.

14. The Li-ion battery as claimed in claim 13, the Li-ion battery having a cut-off voltage of greater than or equal to 4.5 V.

15. A method comprising using the electrolyte composition as claimed in claim 1, the method further comprising increasing the lifespan of an Li-ion battery and/or for improving the electronic performance of an Li-ion battery.
